(19) United States
(12) Patent Application Publication
(10) Pub. No.: US 2009/0106401 A1
(43) Pub. Date: Apr. 23, 2009

(54) System and method for Intra Network Internet Protocol (IP) address modification by dual controller

(75) Inventors: Xiang-Bin Meng, Tianjin (CN); Yan-Peng Yang, Tianjin (CN); Tom Chen, Taipei (TW); Win-Harn Liu, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/976,135

(22) Filed: Oct. 22, 2007

(51) Int. Cl. G06F 15/177

(52) U.S. Cl. 709/220

(57) ABSTRACT

An intranet IP address modification system and method for a dual controller, and is used to modify the intranet IP addresses dynamically under the condition of keeping an intranet based TCP connection of a dual controller from disruption and disconnection. Before modifying the intranet IP address, blocking all data transmission of an intranet connection simultaneously at both ends of the intranet connection of a dual controller; next, re-determining the network card IP's at both ends of the intranet connection based on a conflicting internet IP address; then, revising the intranet IP's and routing table according to the re-determined IP address, modifying correspondingly the remote terminal IP's in an ARP buffer storage and a corresponding MAC address, and modifying correspondingly portal IP address of the intranet connection; and finally, upon the completion of intranet IP address modification, resuming data transmission of the intranet connection simultaneously at both ends of the connection.

### BACKGROUND

1. Field of Invention

The invention relates to an Intra Network Internet Protocol (IP) address modification system and method for a dual controller.

2. Related Art

The major function and objective of a dual controller is to be linked between two computers, so that they can work collectively in cooperation, hereby achieving some specific tasks in a system. In a dual controller, direct communications between two controllers are realized through dual network cards. Wherein, the two pieces of network cards used for direction communication are referred to as intra network cards, while the network card that is connected directly onto the network of user by a dual controller to achieve communications to the outside world is referred to as an inter network card. However, for both the intra network card and inter network card, the communications are carried out through Transfer Control Protocol/Internet Protocol (TCP/IP).

When a dual-controller is activated, communication has to be carried out between the two controllers immediately, namely, an intra network based TCP connection is required to be established. Thus, a fixed and specific network section of Internet Protocol (IP) has to be reserved. In the prior art, at this time, a user is not allowed to set up an intra network IP at the same network section of an inter network card. In case that the same network section of IP is used for both the intra network and inter network, that would result in the consequence that the dual controller could fail to communicate with the outside world. In addition, in case that the user modifies the intra network IP in advance, that could cause the intra network based TCP connection between two controllers of a dual controller to be disconnected. Therefore, an intra network is a basis for the functions and operations of a dual controller, and if the connection between the two controllers of a dual controller established through intra network is disconnected, then the dual controller can not function normally and effectively. Thus, presently, the intra network IP is not allowed to be modified dynamically. As such, there exits the problem in the prior art that there are restrictions in setting up an inter network IP in a specific network section.

### SUMMARY OF THE INVENTION

In view of the problems and shortcomings of the prior art, the objective of the invention is to provide an intra network internet protocol (IP) address modification system and method for a dual controller, that is capable of implementing dynamically the revision of intra network IP which the connection between the two controllers of a dual controller depends on indirectly, thus all the TCP connections between intra networks can be maintained without disruption or disconnection.

In addition, the invention provides an intra network internet protocol (IP) address modification system and method for a dual controller, such that in case that a user set inter network IP is intended to be located in the same network section as the intra network IP, then the intra network IP is dynamically modified, thus ensuring the TCP connections between the intra networks will not be disrupted or disconnected when the intra network IP is revised. Namely, the installation of inter network IP is not subject to any restrictions.

Therefore, the invention provides an intra network internet protocol (IP) address modification system and method for a dual controller, including a blockage/restoration module, an IP modification module, an address resolution protocol (ARP) buffer-storage modification module, and a portal modification module; herein, the blockage/restoration module is used to block/restore all the data transmission of the intra network based TCP connection between a local terminal and a remote terminal of a dual controller; the IP address modification module is used to modify IP address of the network card at local terminal (both remote terminal) of the intra network based TCP connection. The IP address modification module also modifying a routing table at the same time and store the modified IP address of local terminal and remote terminal in an IP storage chain table in a kernel. The ARP buffer-storage modification module is used to modify the corresponding remote terminal IP address of ARP buffer-storage, and modify the remote terminal IP address recorded in a corresponding MAC address according to the remote terminal IP address which is modified by the IP address modification module; and the portal modification module is used to modify the corresponding local (both remote) terminal IP address in a portal of intra network based TCP connection according to the local terminal IP address and remote terminal IP address which are revised by IP address modification module. And the local terminal IP address and the remote terminal IP address are stored in an IP storage chain table.

Preferably, the blockage/restoration module includes a user mode blockage/restoration module, a protocol blockage/restoration module, and a clock blockage/restoration module wherein, the user mode blockage/restoration module is used to block/restore data transmission in a user mode, the protocol blockage/restoration module is used to block/restore the data transmission of a protocol to the lower layer, and clock blockage/restoration module is used to block/restore an overtime clock and a keep-live clock of an intra network based TCP connection.

Moreover, the intra network IP modification system of the invention further includes a determination module, and that is used to determine whether the communication between the local terminal and the remote terminal of intra network based TCP connection is normal, before blocking/restoring the data transmission of an intranet based TCP connection by making use of a blockage/restoration module. Furthermore, an IP negotiation module may be included to proceed with negotiation between local terminal and remote terminal of intra network based TCP connection, and determine the local terminal IP and remote terminal IP to be revised by the IP address modification module based on a conflicting inter network IP of a dual controller.

Furthermore, the invention provides an intra network IP modification method for a dual controller, including the following steps: firstly, blocking simultaneously the data transmission of intra network based TCP connection for a local terminal and a remote terminal of intra network based TCP connection of a dual-controller; next, revising the network card IP of local terminal and remote terminal respectively of intra network based TCP connection, meanwhile, revising a routing table, and storing the revised local terminal IP address and remote terminal IP address in an IP storage chain table in a kernel. Then, revising the remote terminal IP address in an arp buffer-storage and the remote terminal IP address recorded in the corresponding MAC address, according to the revised local terminal IP address and remote terminal IP address. Subsequently, making corresponding modification in a protocol to a portal IP of intra network based TCP connection according to the revised local terminal IP address and remote terminal IP address, and storing the revised local terminal IP address and remote terminal IP address in an IP storage chain table; and finally, restoring data transmission of intra network based TCP connection simultaneously at all the local terminals and remote terminals of intra network based TCP connection.

In addition, the invention provides an intra network internet protocol (IP) modification method, including the following steps: firstly, blocking simultaneously the data transmission of an intra network based TCP connection for the local terminal and remote terminal of an intra network based TCP connection of a dual-controller; next, conducting negotiation between a local terminal and a remote terminal of the intra network based TCP connection, re-determining the IP addresses of local terminal and remote terminal of the intra network based TCP connection by means of a conflicting inter network IP of a dual-controller; then, modifying the network card IP address of the local terminal and remote terminal of an intra network based TCP connection, meanwhile, revising the routing table, and storing the revised local terminal IP address and remote terminal IP address in an IP storage chain table in kernel; subsequently, revising correspondingly the remote terminal IP address in an arp buffer-storage and revising the remote terminal IP address recorded in a corresponding MAC as a re-determined remote terminal IP address; then, revising correspondingly in a protocol the portal IP address of the intra network based TCP connection, and storing the revised local terminal IP address and remote terminal IP address in an IP storage chain table; and finally, restoring the data transmission for an intra network based TCP connection simultaneously at local terminal and remote terminal of an intra network based TCP connection.

In the invention, before the intra network IP address is properly modified, all the data transmission of intra network based TCP connection is temporarily blocked and stopped, hereby providing the prerequisites for dynamically modifying the intra network IP address, meanwhile ensuring that all the TCP connections between the intra networks during modification will not be disrupted and disconnected, as such ensuring the normal operation of the dual controller.

Furthermore, in case that it is intended to place the inter network IP address in the same network section as that of an intra network IP address, and since according to the invention, the intra network IP address can be modified dynamically, thus, the intra network IP address can be revised to avoid coming into conflict with inter network IP address, as such the inter network IP address can be placed and installed without any restrictions.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given herein below and that is for illustration only, and thus are not limitative of the present invention, and wherein:

FIG. 1 is a flowchart of transmitting data in a network by utilizing TCP connection according to the prior art;

FIG. 2 is a system block diagram of an intra network IP address modification system for a dual controller according to an embodiment of the invention;

FIG. 3 is a system flowchart of intra network IP address modification method for a dual controller according to an embodiment of the invention; and

FIG. 4 is a schematic functional diagram for intra network and inter network communication of a dual controller according to an embodiment of the invention.

### DETAILED DESCRIPTION OF THE INVENTION

The purpose, construction, features, and functions of the invention can be appreciated and understood more thoroughly through the following detailed description with reference to the attached drawings.

In the following, the characteristics and implementation of the invention will be described in detail through preferred embodiments together with the accompanying drawings.

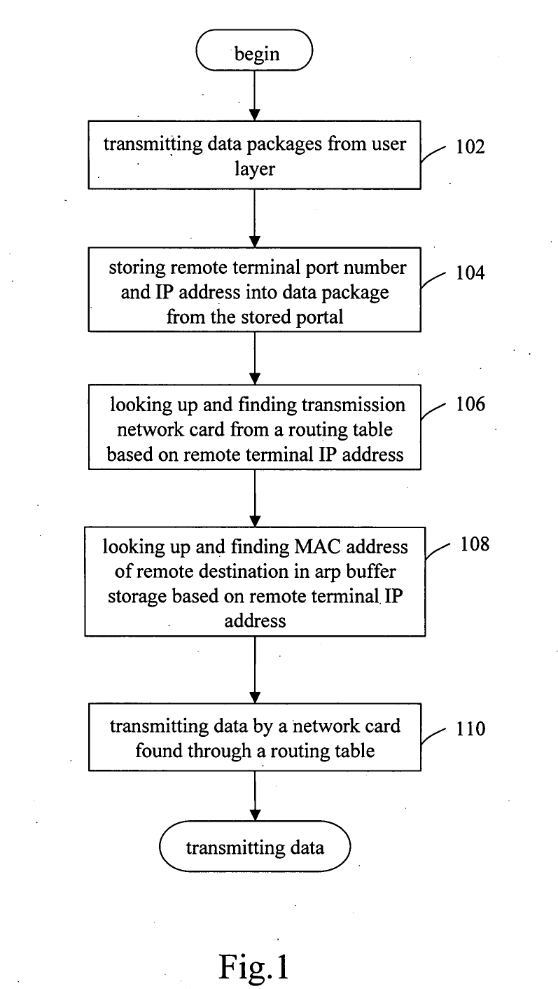

Firstly, refer to FIG. 1 for a flowchart of transmitting data in a network by utilizing TCP connection according to the prior art. Wherein, TCP/IP depends on a pair of portals (IP address & port number) in uniquely identifying a connection, thus the dependence of socket peer on portal is the basis for Transfer Control Protocol (TCP) connection. Thus, in the prior art, the basis of TCP connection is not allowed to change, namely, the IP address of both the transmitting party and the receiving party can not be changed.

Upon the establishment of TCP connection, the portal (IP address & port number) of this connection is stored at local terminal. Therefore, when transmitting data utilizing this connection, a number of steps as shown in FIG. 1 are required. Firstly, the user layer is used to transmit data packets (step 102). Next, upon receiving the data packets, the kernel of the system fetches the port number and IP address of remote destination from the stored portal, and puts them into the data packets (step 104). Then, looking up and finding the transmission network card from a routing table according to the remote destination IP address (step 106). Subsequently, looking up and finding MAC address of destination from an Address Resolution Protocol (ARP) buffer storage according to destination IP (step 108). And finally, transmitting data through a transmission network card look-up and found in a routing table (step 110).

From FIG. 1 it is evident that, in data transmission, step 104, step 106, and step 108 are associated with the IP address of the remote destination. Therefore, in case that the IP address of the remote destination has to be changed, then the corresponding contents of these three steps have to be changed also, while keeping the original connection connected and uninterrupted during the revision.

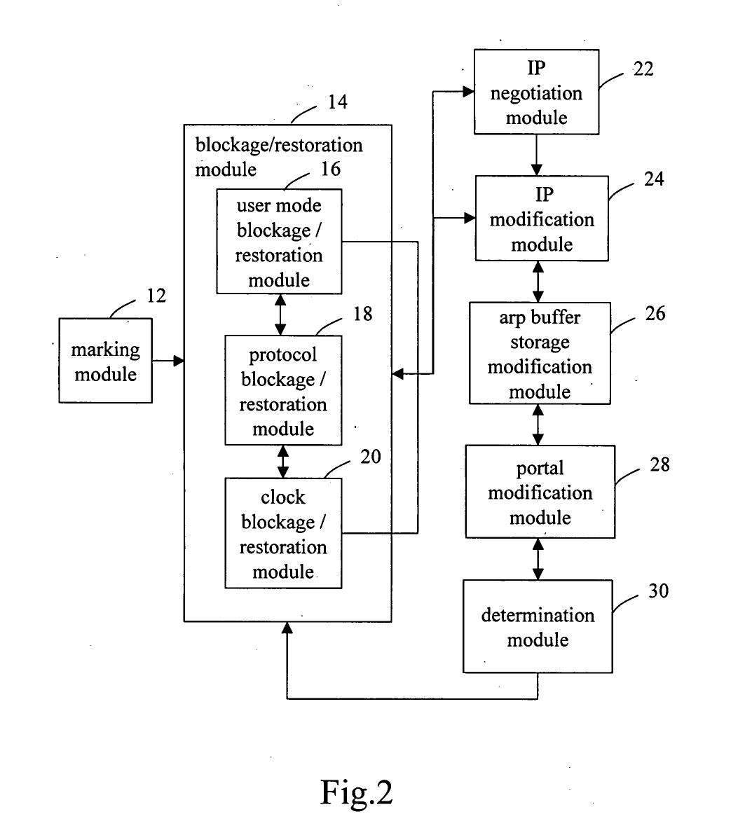

In the following, the intra network IP modification system and method for a dual-controller according to the invention are described in detail in conjunction with FIGS. 2 & 3 & 4.

Firstly, refer to FIG. 2 for a system block diagram of an intra network IP address modification system for a dual controller according to an embodiment of the invention. As shown in FIG. 2, the system mainly includes: a marking module 12, a blockage/restoration module 14, an IP negotiation module 22, an IP modification module 24, an ARP buffer-storage modification module 26, a portal modification module 28, and a determination module 30.

In the first place, upon setting up a TCP connection for a dual controller, a marking module 12 is utilized to add a function in the protocol for marking the intra network based connection. In establishing TCP connection, the related information has to be saved and restored. Thus, an information is added through the marking module 12 for identifying whether the connection is an intra network based TCP connection. As such, in the subsequent revision operations, all the intra network based TCP connections may be obtained easily through this marking.

The blockage/restoration module 14 is used to provide a protection just before the start and during the modification of intra network IP address, thus blocking all the data transmission of intra network based TCP connection, and only after the modification of intra network IP address and the restoration of normal communication, the blockage/restoration module 14 will restore all the data communications of the intra network based TCP connection. In blocking the data communication of the TCP connection, the blockage/restoration module 14 will first conduct negotiations at both ends of the TCP connection, namely the local terminal and remote terminal in realizing the blockage at the same time. And this module will resume data communication at both ends simultaneously after determining that the intra network IP modification has completed successfully.

As shown in FIG. 2, the blockage/restoration module 14 includes a user mode blockage/restoration module 16, a protocol blockage/restoration module 18, and a clock blockage/restoration module 20. The user mode blockage/restoration module 16 is used to block the transmission of data in user mode just before the start and during the modification of intra network IP, namely stopping accepting data in user mode. When data is transmitted to protocol in user mode, two kinds of approaches are adopted by the user mode blockage/restoration module 16 in blocking the transmission of user data. For example, for the synchronous connection between user mode and protocol, and since it is in user mode, the synchronous connection has temporal restrictions on the return values of protocol. Thus, the user mode blockage/restoration module 16 is used to make the protocol send incessantly return values for retrial to the user mode process. For the asynchronous connection between user mode and protocol, and in this case since it is in user mode, the asynchronous connection has no temporal restrictions on the return values of protocol. As such, the user mode blockage/restoration module 16 will keep the protocol waiting and will not send return values to the user. Only after the modification of intra network IP address and the restoration of normal communication, the user mode blockage/restoration module 16 may resume the user mode process and transmit data to the kernel mode.

Similarly, the protocol blockage/restoration module 18 is used to block the data transmission of protocol just before the start and also during the modification of intra network IP address, namely, the TCP layer stops transmitting data to the lower layer; and the TCP layer will resume data transmission to lower layer only after the successful completion of the modification of intra network IP. The clock blockage/restoration module 20 is used to stop the overtime clock and keep-alive clock of intra network based TCP connection just before the start and also during the modification of intra network IP address, and will resume the operation of the above mentioned clocks after the successful modification of intra network IP address. The stoppage of overtime clock is to avoid the occurrence of blockage overtime. When not receiving data transmitted from other terminal, the TCP connection is used to check at regular time intervals if the remote terminal still exists and operational based on the keep-alive clock. As such, the clock blockage/restoration module 20 stops the operation of the keep-alive clock. The TCP connection will no longer execute the above-mentioned check. Thus, when data is transmitted to a remote terminal during blockage, the remote terminal will not consider this blockage has caused the disconnection of TCP connection.

The IP address modification module 24, ARP buffer storage modification module 26, and portal modification module 28 are used to perform modification or adjustment of the corresponding intra network IP address, after the termination of transmission data of local terminal and remote terminal of the intra network based TCP connection. The IP address modification module 24 is used to revise the local terminal IP address and remote terminal IP address of an intra network based TCP connection, meanwhile revising the routing table, such as revising the intranet network card IP's at both ends, and also the record in a routing table through a command (ifconfig,ip) or an IOCEL function. Herein, the revised IP's are stored in a chain table in kernel. While this chain table in kernel keeps all the IP's of the system. Upon completing the revision of intra network IP address by IP modification module 24, the new IP's are stored in that chain table in the kernel.

The ARP buffer-storage modification module 26 is used to revise remote terminal IP under the direction of IP address modification module 24, revise correspondingly the remote terminal IP and the remote terminal IP recorded in corresponding MAC address. For example, the ARP buffer storage can be revised through an order of ARP. The portal modification module 28 is used to revise the network card IP address of intra network of local terminal and remote terminal under the direction of IP modification module 24, revise correspondingly in a protocol the local terminal IP address and remote terminal IP address in a portal of intra network based TCP connection. When establishing a TCP connection, the controllers at both ends will store the portal of this connection in the respective protocols (IP address and port number of the local terminal, and IP address and port number of the remote terminal). Thus, when portal modification module 28 making revisions, it revises the IP in the portal.

The determination module 30 is used to determine if the revised IP address is able to function normally after the modification of intra network IP, namely, determine if the local terminal and remote terminal of intra network based TCP connection may communicate normally to each other. The determination module 30 may conduct checking through a ping order, and in case that the two ends of intra network may ping communicate to each other, then it is determined that the revised IP address may enable intra network to communicate normally.

In addition, as shown in FIG. 2, the intra network IP address modification system may further includes an IP negotiation module 22. The major function of IP negotiation module 22 is to negotiate between local terminal and remote terminal of intra network based TCP connection, when an inter network IP address is intended to be located in the same network section as the current intra network IP address, thus determining the intra network IP address to be modified based on the conflicting inter network IP address, and informing the IP modification module 24 to proceed with the corresponding modification. The negotiation principle of IP negotiation module 22 for the two ends of intra network is that, the network section of a new intra network must not be the same as that of an inter network, and it has to be in the IPv4 reservation address space. Therefore, IP negotiation module 22 reserves a plurality of IP's and masking codes in the IPv4 reservation address space, and selects a pair of IP address and masking code that are not in the same network section as that the conflicting inter network IP address from the IPv4 reservation address space, hereby determining the local terminal IP and remote terminal IP to be revised in an intra network. The intra network IP negotiation algorithm executed by an IP negotiation module 22 will be described in detail as follows.

Firstly, in the system of the respective controllers, reserving a number of (larger than 4 network sections) groups of network sections of IP address (it has to be the network section reserved in IPv4), wherein, each group contains two IP's. In setting up an inter network IP by a user, the controller receives request from the user for comparing the reserved IP network section with the network section of inter network set up by the user, hereby selecting a network section of IP address that is not the same as that of all the inter network IP's. As such, selecting and obtaining two IP address, one of them is used to set up the intra network IP address of the present system utilized at local terminal, and the other is transmitted to the remote terminal for informing it to revise the intra network IP address according to the transmitted IP address.

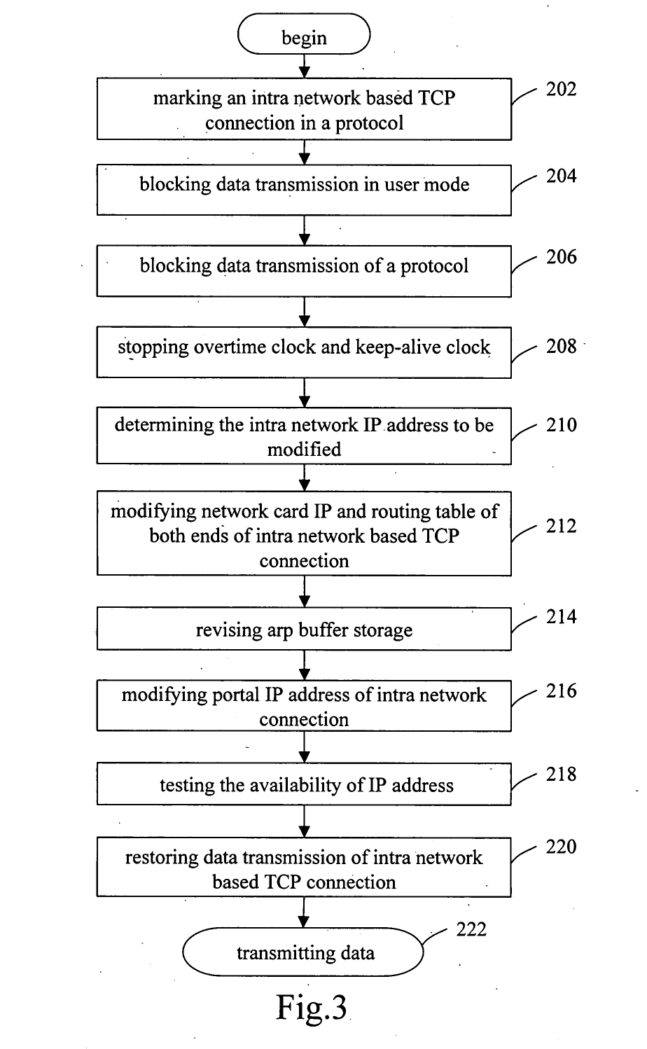

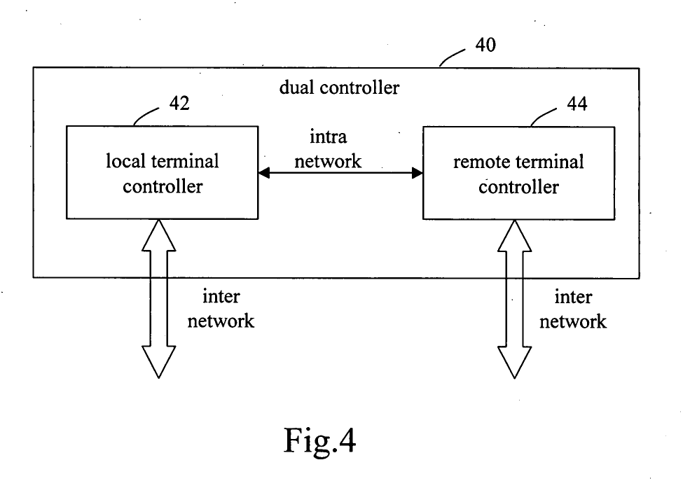

Subsequently, refer to FIGS. 3 & 4. FIG. 3 is a system flowchart of intra network IP address modification method for a dual controller according to an embodiment of the invention. FIG. 4 is a schematic functional diagram for the intra network and inter network communication of a dual controller according to an embodiment of the invention.

In the following, the intra network IP address modification method for a dual controller of the invention is described in conjunction with FIGS. 3 & 4.

As shown in FIG. 4, the dual controller 40 includes a local terminal controller 42 and a remote terminal controller 44, that are combined together in operation and work in cooperation. The local terminal controller 42 communicates directly with remote terminal controller 44 via an intra network, namely, an intra network based TCP connection has to be established. In addition, the local terminal controller 42 and remote terminal controller 44 may communicate to the outside world through the respective internet network cards. Supposing that, the intra network IP address of local terminal controller 42 is 10.0.0.1, the intra network IP address of remote terminal controller 44 is 10.0.0.2, and the mask for both is 255.255.0.0, then the network section is 10.0.0.0. Upon establishing the intra network connection, in an ARP buffer-storage of local terminal controller 42 is provided with an MAC of IP (10.0.0.2) of a remote terminal controller 44. Thus, at this time, the inter network IP address and intra network IP address are located at different network section, thus the intra network and inter network of dual controller 40 may carry out the communication in a normal manner.

Supposing that at this time, the user would like to set up the inter network IP at network section 10.0.0.0, then the current intra network IP address is required to be modified and adjusted. The following is a description of the steps of a flowchart of the intra network IP modification method for a dual controller according to an embodiment of the invention in conjunction with FIG. 3.

Firstly, upon establishing TCP connection of a dual controller, a marking can be placed in a protocol for the intra network based TCP connection (step 202). In establishing a TCP connection, some of the connection related information must be kept and stored, thus, an additional item of information is added to mark and indicate that if it is an intra network based TCP connection, hereby facilitating to obtain all the intra network based TCP connections for used in the subsequent revision operations.

Subsequently, conducting negotiation between the local terminal controller 42 and remote terminal controller 44, thus blocking simultaneously the transmission of data through all the intra network based TCP connections. This operation is performed just before the start and also during the modification of intra network IP to invoke the connection protection function. The action of blocking data transmission of intra network connection can be divided into three steps: Firstly, blocking data transmission in user mode, namely, stopping receiving data of user mode (step 206). Next, for the synchronous connection between user mode and protocol, since it is in user mode, the synchronous connection has temporal restrictions on the return values of protocol. Thus, the protocol is made to send incessantly return values for retrial to the user mode process. For the asynchronous connection between user mode and protocol, in this case since it is in user mode, the asynchronous connection has no temporal restrictions on the return values of protocol, thus keeping the protocol waiting in a kernel mode, and will not send return values to the user. Subsequently, blocking the protocol from executing data transmission, namely, TCP layer is made to stop data transmission to the lower layers (step 207). And finally, stop the overtime clock and keep-alive clock of intra network based TCP connection (step 208). The stoppage of overtime clock is to avoid the occurrence of blockage overtime. When not receiving data transmitted from other end, the TCP connection is used to check at regular time intervals if the remote terminal still exists and operational by utilizing the keep-alive clock. As such, in this step the keep-alive clock is made to stop. The TCP connection will no longer execute the above-mentioned check. Thus when data is transmitted to a remote terminal during blockage, the remote terminal will not consider the blockage has caused the disruption and disconnection of TCP connection.

When the inter network IP is intended to be located in the same network section as the current intra network IP address, then negotiation is required between local terminal and remote terminal of intra network based TCP connection, thus determining the intra network IP address to be revised based on the conflicting inter network IP address (step 210). The negotiation principle for the two ends of intra network is that, the network section of a new intra network must not be the same as that of the inter network, and it has to be in the IPv4 reservation address space. Therefore, a plurality of IP's and a mask have to be reserved in the IPv4 reservation address space, and a pair of IP address and the mask that are not at the same network section of the conflicting inter network IP are selected from the IPv4 reservation address space, hereby determining the intra network IP address and inter network IP address to be revised.

The intra network IP negotiation algorithm mentioned above will be described in detail as follows: Firstly, in the system of the respective controllers, reserving a number of (larger than 4 network sections) groups of IP network sections (it has to be the network section reserved in IPv4), wherein, each group contains two IP's. In setting up an inter network IP address by a user, the controller receives request from the user for comparing the reserved IP network section with the network section of inter network set up by the user, hereby selecting a network section of IP address that is not the same as that of all the inter network IP's. As such, selecting and obtaining two IP's, one of them is used to set up the intra network IP address of the present system utilized at local terminal, and the other is transmitted to the remote terminal for informing it to modify the intra network IP address according to the transmitted IP address.

Supposing that, through the above-mentioned negotiation step, it is determined that, the revised intra network IP's for local terminal and remote terminal are 11.0.0.1 and 11.0.0.2 respectively, and the masking code is 255.255.0.0.

Upon determining the intra network IP is to be revised, executing the corresponding intra network IP modification or adjustments required. Firstly, modifying the local terminal IP address and remote terminal IP address of the intra network based TCP connection, meanwhile, revising the routing table (step 212), such as, revising the record in a intranet network card IP address and routing table at local and remote terminals by means of a command (ifconfig,ip) or a IOCTL function. In revising the intra network IP address by means of an ifconfig command, at the same time the broadcast of system arp is closed and stopped, and it will be re-opened and resumed after the completion of IP modification. In kernel is provided a chain table for keeping all the IP's of the system. Upon completion of intra network IP modification through the afore-mentioned command, the new intra network IP address will be stored in this chain table in kernel for keeping all the P's. Moreover, the IP address in a configuration file for intra network (under “/etc/sysconfig/network-scripts/”) is also revised to the newly revised IP address. As such, when the system is reactivated, the intra network IP address is the newly revised IP address.

Then, revising correspondingly the remote terminal IP address in ARP buffer storage, and the remote terminal IP recorded in the corresponding MAC according to the remote terminal IP determined (step 124). By way of example, an ARP buffer storage can be revised through an ARP command, such as, revising the remote terminal IP address of an ARP buffer storage as 11.0.0.2. Subsequently, modifying in the protocol the corresponding local terminal IP address and remote terminal IP address in a portal of intra network based TCP connection according to the re-determined intranet network cards of local terminal and remote terminal (step 216). In establishing a TCP connection, the controllers at both ends will store the portal of this connection in the respective local protocols (local end IP and port, and remote terminal IP address and port number). Thus in making a modification, it is the IP in the portal that is modified. For example, the intra network IP address of local terminal controller 42 is modified as 11.0.0.1, while the intra network IP address of remote terminal controller 44 is modified as 11.0.0.2.

Upon completion of intra network IP address modification, then it can be checked and examined through a ping command, so as to determine whether the modified IP may function normally, namely to determine that if the local terminal and remote terminal of the intra network based TCP connection may communicate to each other normally at this time (step 218). If it is determined that the TCP connection may function normally, then resuming the data transmission of intra network based TCP connection, and informing the kernel mode protocol to resume data transmission (step 220). The restoration of data transmission of intra network based TCP connection includes: restoration of the operations of overtime clock and keep-alive clock, restoration of transmission of data from the protocol to the lower layers, and the restoration of data transmission from user mode to protocol. Finally, resuming the transmission of data in normal communication conditions (step 222).

As such, through the application of the above-mentioned steps of the intra network IP modification method of the invention, the communications of all intra network based TCP connections of a dual controller are carried out by making use of the newly revised intra network IP address. Therefore, through the application of the invention, it can be ensured that not only the intra network IP address can be adjusted dynamically under the condition without having to interrupt the intra network based TCP connection, but the intra network IP address can also be modified correspondingly based on a conflicting inter network IP set by a user. As such, the set-up of inter network IP address is in no way affected and restricted by the intra network IP.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An intra network IP address modification system for a dual controller, comprising:
a blockage/restoration module, used to block/restore data transmission of an intra network based TCP connection simultaneously at a local terminal and a remote terminal of said intra network based TCP connection for said dual controller;
an Internet Protocol (IP) modification module, used to modify the network card IP at local terminal and remote terminal of the intra network based TCP connection, meanwhile, revise a routing table, and store the revised local terminal and remote terminal IP's in an IP storage chain table in a kernel;
an Address Resolution Protocol (ARP) buffer-storage modification module, used to modify correspondingly said remote terminal IP address of an ARP buffer-storage and said remote terminal IP address recorded in a corresponding MAC according to the remote terminal IP address modified by said IP address modification module; and
a portal modification module, used to revise correspondingly in a protocol said local and remote terminal IP's in a portal of said intra network based TCP connection according to said local terminal IP address and said remote terminal IP address modified by IP address modification module, and store the modified local terminal IP address and remote terminal IP address in said IP storage chain table.

2. The intra network IP address modification system for a dual controller as claimed in claim 1, wherein
said blockage/restoration module further comprising:
a user mode blockage/restoration module, used to block/restore data transmission in a user mode,
a protocol blockage/restoration module, used to block/restore the data transmission of a protocol to the lower layers, and
a clock blockage/restoration module, used to block/restore an overtime clock and a keep-live clock of an intra network based TCP connection.

3. The intra network IP address modification system for a dual controller as claimed in claim 1, further comprising:
a determination module, used to determine whether the communication between said local terminal and said remote terminal of said intra network based TCP connection is normal, before blocking and restoring the data transmission of said intra network TCP connection by said blockage/restoration module.

4. The intra network IP address modification system for a dual controller as claimed in claim 1, further comprising:
a marking module, used to mark in said protocol said intra network based TCP connection, upon the establishment of TCP connection of said dual controller.

5. The intra network IP address modification system for a dual controller as claimed in claim 1, further comprising:
an IP negotiation module, used to proceed with negotiation at said local terminal and said remote terminal of said intra network based TCP connection, and determine said local terminal IP address and said remote terminal IP address modified by said IP modification module as based on a conflicting inter network IP address of said dual controller.

6. The intra network IP address modification system for a dual controller as claimed in claim 1, wherein:
said IP negotiation module is used to reserve a plurality of IP's and a mask in an IPv4 reservation address space, and select a pair of IP and the mask that are not in the same network section as that of said conflicting inter network IP from said IPv4 reservation address space, thus determining said local terminal IP address and said remote terminal IP address to be modified.

7. An intra network IP address modification method for a dual controller, comprising the following steps:
blocking the data transmission of an intra network based TCP connection simultaneously at a local terminal and a remote terminal of said intra network based TCP connection of said dual controller;
revising a local terminal IP address and a remote terminal IP address of said intra network based TCP connection respectively, meanwhile, revising a routing table, and storing the revised local terminal and remote terminal IP's in an IP storage chain table in a kernel;
revising correspondingly said remote terminal IP address in an ARP buffer-storage and said remote terminal IP recorded in a corresponding MAC, according to the revised local terminal IP address and remote terminal IP address;
revising correspondingly in a protocol a portal IP address of said intra network based TCP connection according to said revised local terminal IP address and said revised remote terminal IP address, and storing said revised local terminal IP address and said revised remote terminal IP address in said IP storage chain table; and
restoring data transmission of said intra network based TCP connection simultaneously at said local terminal and said remote terminal of said intra network based TCP connection.

8. The intra network IP address modification method for a dual controller as claimed in claim 7, wherein:
the step of blocking the data transmission of said intra network based TCP connection further includes the following steps:
blocking user mode data transmission;
blocking data transmission of a protocol to the lower layers; and
stopping the overtime clock and keep-alive clock of said intra network based TCP connection.

9. The intra network IP address modification method for a dual controller as claimed in claim 8, wherein
when the connection between user mode and protocol is a synchronous connection, the step of blocking user mode data transmission further includes the step of making said protocol transmit incessantly the return values for retrial to user mode process.

10. The intra network IP address modification method for a dual controller as claimed in claim 8, wherein
when said connection between said user mode and said protocol is an asynchronous connection, the step of blocking user mode data transmission further includes the step of keeping the protocol waiting.

11. The intra network IP address modification method for a dual controller as claimed in claim 7, wherein
the step of restoring data transmission of said intra network based TCP connection further includes the following steps:
restoring said overtime clock and said keep-alive clock of said intra network based TCP connection;
restoring data transmission of said protocol to said lower layers; and
restoring data transmission from user mode to kernel mode.

12. The intra network IP address modification method for a dual controller as claimed in claim 7, further comprising the step of:
before the step of restoring data transmission of said intra network based TCP connection, determining whether the communication between said local terminal and said remote terminal of said intra network based TCP connection is normal.

13. The intra network IP address modification method for a dual controller as claimed in claim 7, further comprising the step of:
upon establishing said TCP connection of said dual controller, marking said intra network based TCP connection in said protocol.

14. The intra network IP address modification method for a dual controller as claimed in claim 7, further comprising the step of:
negotiating at said local terminal and said remote terminal of said intra network based TCP connection, and determining said local terminal IP address and said remote terminal IP address to be revised based on a conflicting inter network IP address of said dual controller.

15. The intra network IP address modification method for a dual controller as claimed in claim 14, wherein
the step of negotiating and determining said local terminal IP address and said remote terminal IP address to be revised includes the following steps:
reserving a plurality of IP's and masking codes in an IPv4 reservation address space; and
selecting a pair of IP address and the mask that are not in the same network section as that of said conflicting inter network IP address from said IPv4 reservation address space, hereby determining said local terminal IP address and said remote terminal IP address to be revised.

16. An intra network IP address modification method for a dual controller, comprising the following steps:
blocking the data transmission of an intra network based TCP connection simultaneously at the local terminal and remote terminal of said intra network based TCP connection of a dual-controller;
conducting negotiation at said local terminal and said remote terminal of said intra network based TCP connection, re-determining the IP addresses of said local terminal and said remote terminal of said intra network based TCP connection based on a conflicting inter network IP address of said dual controller;
revising a local terminal IP address and a remote terminal IP address of said intra network based TCP connection according to said re-determined IP address, meanwhile, revising the routing table, and storing said revised local terminal IP address and remote terminal IP address in an IP storage chain table in a kernel;
revising correspondingly said remote terminal IP address in an ARP buffer-storage and said remote terminal IP address recorded in a corresponding MAC, thus re-determining the remote terminal IP address;
revising correspondingly in a protocol the portal IP address of said intra network based TCP connection according to said re-determined local terminal IP address and said remote terminal IP address, and storing the revised local terminal IP address and remote terminal IP address in said IP storage chain table; and
restoring the data transmission of said intra network based TCP connection simultaneously at said local terminal and said remote terminal of all said intra network based TCP connections.

17. The intra network IP address modification method for a dual controller as claimed in claim 16, wherein
the step of conducting negotiation at said local terminal and said remote terminal of said intra network based TCP connection, hereby re-determining the IP addresses of said local terminal and said remote terminal, further includes the following steps:
reserving a plurality of IP's and the mask in an IPv4 reservation address space; and
selecting a pair of IP and the mask that are not in the same network section as that of said conflicting inter network IP from said IPv4 reservation address space, hereby determining said IP addresses of said local terminal and said remote terminal.

18. The intra network IP address modification method for a dual controller as claimed in claim 16, wherein
the step of blocking data transmission of said intra network based TCP connection, further includes the following steps:
blocking user mode data transmission;
blocking data transmission of a protocol to the lower layers; and
stopping the overtime clock and keep-alive clock of said intra network based TCP connection.

19. The intra network IP address modification method for a dual controller as claimed in claim 18, wherein
when the connection between said user mode and said protocol is a synchronous connection, the step of blocking user mode data transmission further includes the step of making the protocol transmit incessantly the return values for retrial to user mode process.

20. The intra network IP address modification method for a dual controller as claimed in claim 16, wherein
the step of restoring data transmission of said intra network based TCP connection further includes the following steps:
restoring said overtime clock and said keep-alive clock of said intra network based TCP connection;
restoring data transmission of a protocol to said lower layers; and
restoring data transmission from user mode to kernel mode.
